(19) United States
(12) Patent Application Publication
(10) Pub. No.: US 2023/0122465 A1
(43) Pub. Date: Apr. 20, 2023

(54) VEHICLE HANDS-FREE CALL CONNECTION SYSTEM

(71) Applicant: Young Sam SON, Yangsan-si Gyeongsangnam-do (KR)

(72) Inventor: Young Sam SON, Yangsan-si Gyeongsangnam-do (KR)

(21) Appl. No.: 17/907,497

(22) PCT Filed: Mar. 23, 2021
(86) PCT No.: PCT/KR2021/003587

§ 371 Date: Sep. 27, 2022

(30) Foreign Application Priority Data
Apr. 7, 2020 (KR) 10-2020-0042239

(51) Int. Cl. H04M 3/42; H04M 1/60; B60K 35/00

(52) U.S. Cl. CPC H04M 3/42042; H04M 1/6075; B60K 35/00; B60K 2370/1529; B60K 2370/16; B60K 2370/56

(57) ABSTRACT

Proposed is a vehicle hands-free incoming call notification system that is connected to a driver's phone through short-range wireless communication and supports a hands-free function. The system includes a caller information reception unit configured to receive caller information through the short-range wireless communication from a driver's phone to which an incoming call is connected according to a call origination of a caller terminal, and a notification unit for a driver configured to output the received caller information to at least some displays among a plurality of vehicle displays, to output an incoming call tone to a speaker, but when an incoming call-incognito mode is set, to output the caller information only to at least one exclusive display for a driver so that only the driver is able to check.

### TECHNICAL FIELD

The present disclosure relates to a vehicle hands-free call connection system.

### BACKGROUND ART

As is well known, hands-free technology for a vehicle is a technology for outputting another party's voice signal transmitted to a vehicle driver's mobile phone to a speaker of a vehicle and transmitting a driver's voice input through a microphone provided in the vehicle to the other party through the mobile phone. Through this technology, a driver may make a phone call with the other party more conveniently. In relation to this, Korean Patent No. 10-0867702 discloses a hands-free device for a vehicle. The hands-free device for the vehicle includes a microphone and a speaker for a front seat and a microphone and a speaker for a rear seat. In addition, hands-free switching is accomplished so as to make only either one of the microphone/speaker for the front seat or the microphone/speaker for the rear seat be activated according to the passenger's input of the switching button.

That is, the hands-free device for a vehicle according to the above publication enables a hands-free call conversion between a front seat and a rear seat to be made for a rear seat occupant, so that the rear seat occupant may also smoothly communicate with the other party.

On the other hand, when the driver receives an incoming call while a vehicle hands-free mode is set, caller information is displayed on a touch screen of the vehicle, so in general, the driver checks who a caller is and then accepts the call to communicate with the other party. However, even when a passenger is on board and a call is received from the caller with whom the passenger has a bad relationship, the passenger may also check the caller information displayed on the touch screen, which may cause a difficult situation. In addition, since the caller has no knowledge of whether the other party is receiving a call using the vehicle hands -free mode, the caller may speak inappropriately as soon as the call is connected. Therefore, although the vehicle hands-free mode is for the driver's convenience, the problems resulting therefrom may put the driver in a difficult situation.

### DISCLOSURE

### Technical Problem

Accordingly, the present disclosure has been made keeping in mind the above problems occurring in related art and is intended to provide a technical solution for solving problems that may cause a driver to be in a difficult situation due to a vehicle hands-free mode.

### Technical Solution

In order to accomplish the above objectives, there may be provided a vehicle hands-free call connection system, wherein a vehicle hands-free call notification system includes a controller for supporting a hands-free function by being connected to a driver's phone and short-range wireless communication, the controller including: a caller information reception unit configured to receive caller information through the short-range wireless communication from a driver's phone to which an incoming call is connected according to a call origination of a caller terminal; and a notification unit for a driver configured to output received caller information to at least some displays among a plurality of vehicle displays and, when an incoming call-incognito mode is set, to output the caller information only to at least one exclusive display for the driver so that only the driver is able to check the caller information.

The notification unit for a driver may output the caller information to at least one of a heads-up display, which is an exclusive display for the driver, and a digital cluster.

The controller may further include an incognito mode setting unit configured to automatically set the incoming call-incognito mode when it is detected that a passenger is boarded.

The notification unit for a driver may output an incoming call tone along with the caller information and, only when the incoming call-incognito mode is not set, however, output the incoming call tone.

When the incoming call-incognito mode is set, the notification unit for a driver may notify the driver of an incoming call by activating a vibration motor provided in a driver's body contact area in place of outputting the incoming call tone.

The controller may further include a situation notification unit configured to transmit voice messages to a caller through the driver's phone for notifying the caller that a call is connected in a vehicle hands-free mode or that a passenger is on board, when a call channel is made between the driver's phone and the caller terminal according to a driver's acceptance command for a talk with respect to the incoming call.

The controller may further include a call processing unit configured not to output a caller's voice received from the driver's phone through the short-range wireless communication to a speaker during voice message guidance by the situation notification unit.

The controller may further include a call method setting unit configured to allow, according to a driver's button input pattern for call acceptance, a call to be accomplished through a microphone and speaker of the driver's phone by notifying vehicle hands-free deactivation to the driver's phone or the call to be accomplished through a microphone and speaker of the vehicle by notifying vehicle hands-free activation to the driver's phone and to allow switching to be accomplished between the hands-free activation and hands-free deactivation of the vehicle according to the driver's button input pattern in a state call acceptance is made.

On the other hand, there may be provided a vehicle hands-free call connection method, wherein a vehicle hands-free incoming call notification method is performed by at least one process belonging to a vehicle hands-free incoming call notification system for supporting a hands-free function by being connected to a driver's phone and short-range wireless communication, according to one aspect, the connection method including: receiving caller information through the short-range wireless communication from the driver's phone to which an incoming call is connected according to a call origination of a caller terminal; and outputting received caller information to at least some displays among a plurality of vehicle displays and, when an incoming call-incognito mode is set, however, outputting the caller information only to at least one exclusive display for a driver so that only the driver is able to check the caller information.

### Advantageous Effects

According to the present disclosure, when a call is received even when the vehicle hands-free mode is set, caller information is displayed only on a heads-up display that only the driver can check, so that the caller information is prevented from being exposed to a fellow passenger. In addition, the present disclosure let the caller recognize the other party is receiving a call using the vehicle hands-free mode, so it is possible to prevent inappropriate speech from being heard. That is, according to the present disclosure, problems in which the driver is put in a difficult situation due to the vehicle hands-free mode can be solved.

### DESCRIPTION OF DRAWINGS

FIG. 1 is a block diagram of a hands-free telephone connection system according to an embodiment.

FIG. 2 is a block diagram of a vehicle system according to the embodiment.

FIG. 3 is an exemplary view of a heads-up display screen.

FIGS. 4 to 6 are flowcharts of a vehicle hands-free phone connection method according to an embodiment.

### MODE FOR INVENTION

The foregoing and further aspects of the present disclosure will become more apparent through preferred embodiments described with reference to the accompanying drawings. Hereinafter, the present disclosure will be described in detail so that those skilled in the art may easily understand and reproduce it through such examples.

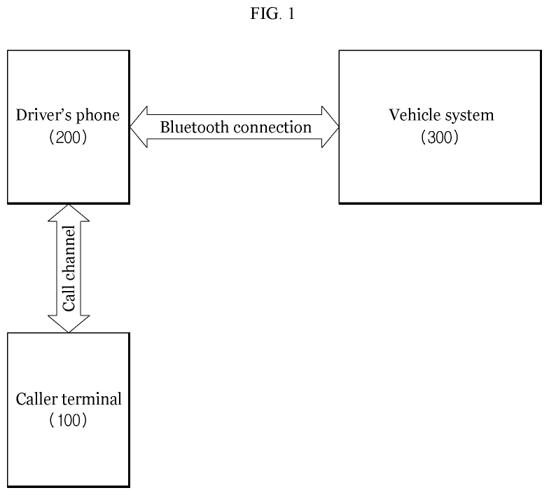

FIG. 1 is a block diagram of a hands-free telephone connection system according to an embodiment. Both a caller terminal 100 and a driver's phone 200 are communication terminals having a telephone function and may be mobile terminals such as a smartphone. The caller terminal 100 performs a call origination according to a caller command, and the driver's phone 200 makes a call channel with the caller terminal 100 according to the driver's call acceptance command for an incoming call according to the call origination of the caller terminal 100, thereby enabling a caller and a driver to talk on the phone. The driver's phone 200 includes a short-range communication module for short-range wireless communication connection with other devices. In one embodiment, the short-range communication module is a Bluetooth module. A vehicle hands-free phone connection system (hereinafter referred to as a “vehicle system”) is a system provided in a vehicle and may include at least one electronic device. The vehicle system 300 is connected to the driver's phone 200 by short-range wireless communication to support the vehicle hands-free function to the driver, thereby providing the driver with service functions to solve problems that may cause the driver to be put in a difficult situation due to the vehicle hands-free mode when a passenger is on board.

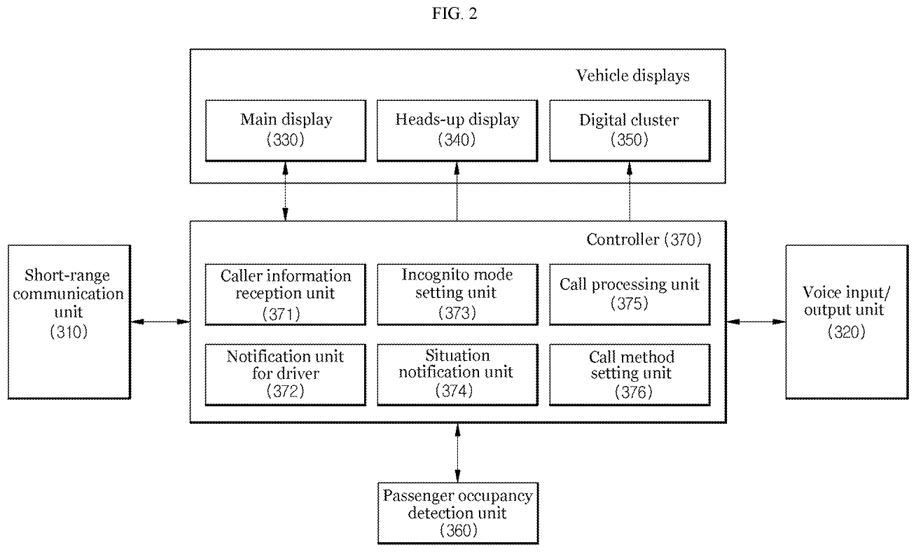

FIG. 2 is a block diagram of a vehicle system according to the embodiment. A short-range communication unit 310 is connected to the driver's phone 200 by short-range wireless communication so as to support the hands-free mode and may be a Bluetooth module. A voice input/output unit 320 includes a microphone for voice input and a speaker for voice output. Vehicle displays may include a display or displays that may be checked by not only the driver but also the passenger and a display or displays exclusive to the driver. As a former display, a main display 330, which is typically located between a driver's seat and a front passenger seat and provides a user input/output interface, is exemplified, and as a latter display, a heads-up display 340 or a digital cluster 350 is exemplified. For reference, the driver may set various vehicle functions by manipulating the main display 330 by touch. The heads-up display 340 is a display that is provided on the windshield of the vehicle to graphically show the vehicle speed, fuel remaining, and road guidance information to the driver. The digital cluster 350 is an instrument panel display and provides various vehicle information such as door open/close, battery charge/discharge status, brake status, and the like.

A passenger occupancy detection unit 360 is a sensor for detecting whether the passenger is in the passenger seat or a rear seat. The sensor for detecting the passenger's occupancy may include but is not limited to a weight sensor provided in a seat to detect weight. A controller 370 is a configuration for controlling the overall vehicle system and may be composed of a combination of hardware and software including at least one processor. The controller 370 may set a hands-free mode by accomplishing a short-range wireless communication connection with the driver's phone 200 through the short-range communication unit 310. As shown in FIG. 2, the controller 370 may include at least one of a caller information reception unit 371, a notification unit for a driver 372, an incognito mode setting unit 373, a situation notification unit 374, a call processing unit 375, and a call method setting unit 376, and all of these configurations may be implemented in software and recorded in a memory in the form of a program code. In addition, such units may be executed by at least one processor belonging to the controller 370 to perform a corresponding process.

The caller information reception unit 371 receives caller information through the short-range communication unit 310 from the driver's phone in which the incoming call is connected according to the call origination of the caller terminal 100 in a state in which the hands-free mode is set. The caller information may include at least one of a caller name and a caller phone number. The notification unit for a driver 372 outputs the received caller information to at least some displays among a plurality of vehicle displays so that the driver may check in advance who made the call before answering the call. In this case, the notification unit for a driver 372 may output an incoming call tone to the speaker to inform the driver audibly that the incoming call has been received.

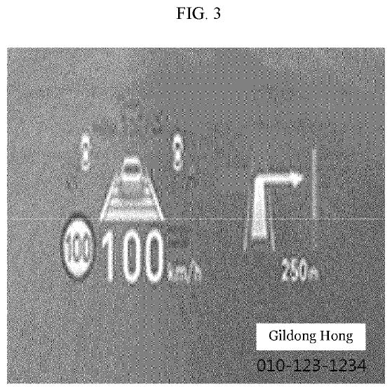

When the incoming call-incognito mode is set, the notification unit for a driver 372 according to an aspect outputs the caller information only to an exclusive display for the driver, for example, to at least one of the heads-up display 340 and the digital cluster 350, so that only the driver may check the caller information. Here, the incoming call-incognito mode means a mode for preventing caller information from being exposed to a passenger and, furthermore, may also mean a mode for preventing the passenger from recognizing an incoming call itself. It is difficult for passengers other than the driver to check the contents displayed on the heads-up display 340 or the digital cluster 350 located in front of the driver, so it is possible to prevent the passengers from checking caller information by outputting only to the heads-up display 340 or the digital cluster 350 as illustrated in FIG. 3.

Meanwhile, the notification unit for a driver 372 may output an incoming call tone only when the incoming call-incognito mode is not set. That is, when the incoming call-incognito mode is set, the incoming call tone is not output. The reason for doing so is not to allow the passenger to know that an incoming call has been received. Alternatively, the notification unit for a driver 372 may notify the driver of an incoming call by activating a vibration motor provided on the driver's body contact area, for example, a steering wheel or the driver's seat, in place of outputting the incoming call tone, and according to this, it is possible to easily notify only the driver the incoming call has been received while preventing the passenger from recognizing the incoming call has been received. Meanwhile, the incoming call-incognito mode may be set through a driver's touch screen operation.

The incognito mode setting unit 373 automatically sets the incoming call-incognito mode when it is detected that the passenger is on board by the passenger occupancy detection unit 360. In one embodiment, in a state in which the driver's phone 200 and the vehicle system 300 are connected to the short-range wireless communication so that the hands-free mode is activated, the incognito mode setting unit 373 automatically sets the incognito mode under the condition that only when a passenger is detected to be on board by the passenger's occupancy detection unit 360. According to this, even when the driver has not yet set the incoming call-incognito mode, the incoming call-incognito mode is automatically set when a passenger is on board, so that the caller information may be prevented from being exposed to the passenger.

The situation notification unit 374 is a configuration for guiding voice messages to the caller terminal 100. As is well known, when, after checking caller information, the driver commands to accept a call for an incoming call, that is, presses a call acceptance button provided on the steering wheel and the like, a call channel is made between the driver's phone 200 and the caller terminal 100. When a call channel is made between the driver's phone 200 and the caller terminal 100 as described above, the situation notification unit 374 transmits the voice messages previously stored in the memory to the driver's phone 200 through the short-range communication unit 310, thereby allowing the voice messages to be transmitted to the caller terminal 100 through the call channel. In this case, the voice messages delivered to the caller may be a message informing that the driver is in a state of having the call connected in the vehicle hands-free mode or a message informing that a passenger is on board. According to this, as soon as the call is connected, the caller may hear the voice messages and understand the environment of the call of another party, thereby preventing inappropriate speech from being heard.

The call processing unit 375 transmits a voice input through the microphone of the voice input/output unit 320 to the driver's phone 200 through the short-range communication unit 310, thereby allowing the voice to be transmitted to the caller terminal 100 and performs a well-known call voice processing for outputting the caller's voice received from the driver's phone 200 to the outside through the speaker of the voice input/output unit 320. The call processing unit 375 according to an aspect does not output the caller's voice, received through the short-range communication unit 310 during the voice messages are guided by the situation notification unit 374, to a speaker of the voice input/output unit 320 and outputs the caller's voice only received from the point in time when voice message guidance is finished to the speaker. According to this, the problem that the caller may speak inappropriately without even hearing the voice messages as soon as the call channel is made may be prevented.

The call method setting unit 376 sets a call method differently so that a call is made using the microphone and speaker of the vehicle or the call is made using the microphone and speaker of the driver's phone 200 according to the driver's button input pattern. That is, even when the vehicle hands-free mode is set, a call is made in one of a vehicle call mode and a phone call mode by taking the driver's button input pattern into consideration. For example, in the incoming call state, the call method setting unit 376 allows, when the driver checks the caller information and presses the call acceptance button once, a call to be made in the vehicle call mode as in the past and allows, when the driver checks the caller information and presses the call acceptance button twice, a call to be made through the microphone and speaker of the driver's phone 200 by notifying the vehicle hands-free deactivation to the driver's phone 200 through the short-range communication unit 310.

In addition, the call method setting unit 376 may allow switching between the vehicle call mode and the phone call mode to be accomplished according to the driver's specific button input pattern even after the call channel is made. For example, when the driver presses a specific button once in a state while the call is being made in the phone call mode, the call method setting unit 376 allows the call to be made through the vehicle's microphone and speaker by notifying the vehicle hands-free activation to the driver's phone 200, and when the driver presses a specific button twice in a state while the call is being made in the vehicle call mode, the call method setting unit 376 allows the call to be made through the microphone and speaker of the driver's phone 200 by notifying the vehicle hands-free deactivation to the driver's phone 200. That is, the call method setting unit 376 may allow the call mode to be switched even during the call.

Meanwhile, when the call acceptance is made and when the call is terminated, the notification unit for a driver 372 may display a graphic image for notifying each of the situations on the heads-up display 340 and/or the digital cluster 350. For example, the notification unit for a driver 372 displays an edge region of the screen of the heads-up display 340 in green when a call is connected and displays the edge region of the screen of the heads-up display 340 in red when the call is terminated. In addition, when the driver does not operate any manipulation during an incoming call, the notification unit for a driver 372, to prevent obstruction of view of the screen, may make the display size of the caller information gradually reduce or may make the display size of the caller information appear for no less than a few seconds and then disappear from the screen. In addition, the notification unit for a driver 372 may also display a related graphic image on the heads-up display 340 for the duration a call is connected. In addition, the driver notification unit 372 may also display a graphic image for notifying the speed camera on the heads-up display 340. For example, the notification unit for a driver 372 may display a screen edge region of the head-up display 340 to blink in red to warn the driver of speeding enforcement.

On the other hand, when the driver commands a call rejection with respect to an incoming call, that is, presses a call rejection button provided on the steering and the like in a state in which the incognito mode is set, a call channel is not made between the driver's phone 200 and the caller terminal 100, and an incoming call state is terminated. When the driver's call rejection command occurs while the incoming call-incognito mode is set, the situation notification unit 374 causes the driver's phone 200 to transmit a situation notification message to the caller terminal 100. The situation notification message may be pre-stored in the memory of the vehicle system 300 or may be stored in the driver's phone 200. In the former case, the situation notification unit 374 may command the driver's phone 200 to transmit the situation notification message to the caller terminal 100 while transmitting the situation notification message to the driver's phone 200. Accordingly, the driver's phone 200 transmits a situation notification message to the caller terminal 100 through data communication. Here, the situation notification message may also be a text message or a voice message, and the content may indicate that a call is difficult to receive because the driver is with a passenger on board.

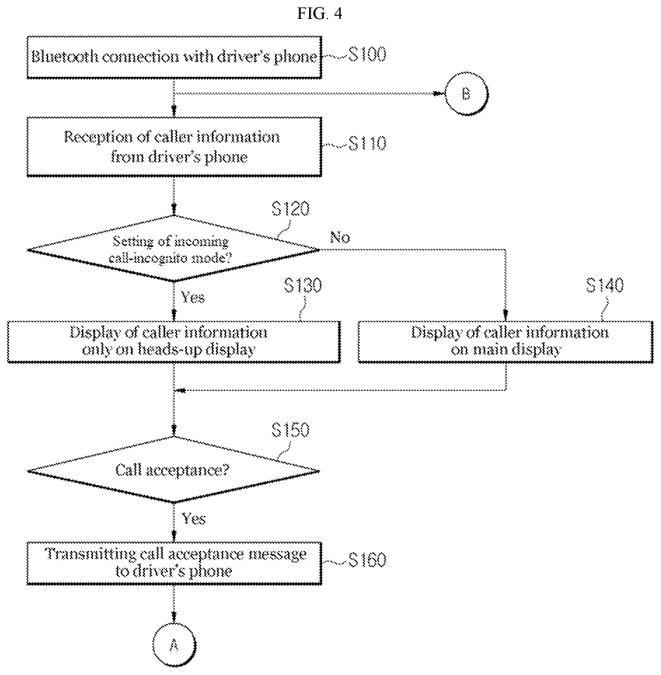

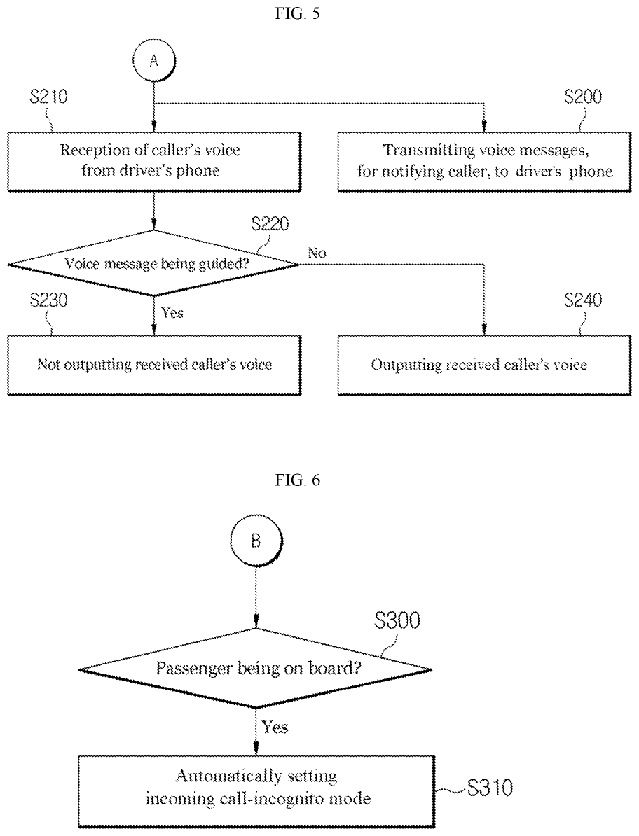

FIGS. 4 to 6 are flowcharts of a vehicle hands-free phone connection method according to an embodiment. The vehicle system 300 makes a Bluetooth connection with the driver's phone through the short-range communication unit 310 to establish a vehicle hands-free mode in S100. In this case, it is not necessarily limited to Bluetooth. When an incoming call is connected to the driver's phone 200, the vehicle system 300 receives caller information from the driver's phone 200 in S110. The vehicle system 300 checks whether the incoming call-incognito mode is set in S120, when the incoming call-incognito mode is set, displays caller information only on the heads-up display 340 in S130, and when the incoming call-incognito mode is not set, displays the caller information “Gildong Hong, 010-123-1234” on the main display 330 in S140. In S140, the vehicle system 300 may also display the caller information on a display other than the main display 330.

In addition, when the caller information is received, the vehicle system 300 may output an incoming call tone to notify the passenger that an incoming call has been received, wherein when the incoming call-incognito mode is set, an incoming call tone is not output, and only when the incoming call-incognito mode is not set, the incoming call tone may be output. Alternatively, when the incoming call-incognito mode is set, the vehicle system 300 activates a vibration motor for generating vibration at a body contact area of the driver, such as the steering wheel or the driver's seat, in place of outputting the incoming call tone and may notify the driver that the incoming call is received.

After S130 or S140, when there is a call acceptance command from the driver, the vehicle system 300 transmits a call acceptance message to the driver's phone 200, thereby allowing a call channel to be made between the driver's phone 200 and the caller terminal 100 in S150 and S160.

The vehicle system 300 transmits predetermined voice messages to the driver's phone 200 after S160, so that the voice messages are to be transmitted to the caller terminal 100 in S200. In addition, the vehicle system 300 receives the caller's voice from the driver's phone 200 in S210 after the call channel is established after S160. When the caller's voice is received, the vehicle system 300 checks in S220 whether the voice messages in S200 are being guided or are finished for the guidance. When the voice messages are being guided, the vehicle system 300 does not output the caller's voice received from the driver's phone 200 to the speaker in S230. When the voice messages are finished for the guidance, the vehicle system 300 outputs the caller's voice received from the driver's phone 200 to the speaker in S240. That is, the vehicle system 300 blocks output to the speaker with respect to the caller's voice received while the voice messages are being guided. Meanwhile, S200 may be omitted, and in this case, S220 and S230 are also naturally omitted.

Additionally, the vehicle system 300 may check in S300 whether a passenger is boarded after S100. When it is checked that the passenger is on board, the vehicle system 300 automatically sets the incoming call-incognito mode in S310. On the other hand, in FIG. 4, when the incoming call-incognito mode is set, the caller information is exemplified as being displayed only on the heads-up display 340, but as described above, it may be displayed on at least one of the heads-up display 340 and the digital cluster 350. Alternatively, when other exclusive displays for the driver exist in addition to the heads-up display 340 and the digital cluster 350, the caller information may be displayed on such displays.

Introduced so far are the exemplified embodiments with respect to the present disclosure. Those of ordinary skill in the art to which the present disclosure pertains will understand that the present disclosure may be implemented in a modified form without departing from the essential characteristics of the present disclosure. Therefore, the disclosed embodiments are to be considered from an illustrative point of view rather than a restrictive point of view. The scope of the present disclosure is indicated in the claims rather than the foregoing description, and all differences within the scope equivalent thereto should be construed as being included in the present disclosure.

1. A vehicle hands-free call connection system, wherein a vehicle hands-free incoming call notification system comprises a controller configured to support a hands-free function by being connected to a driver's phone and short-range wireless communication, the controller comprising:
a caller information reception unit configured to receive caller information through the short-range wireless communication from a driver's phone to which an incoming call is connected according to a call origination of a caller terminal; and
a notification unit for a driver configured to output received caller information to at least some displays among a plurality of vehicle displays and, when an incoming call-incognito mode is set, to output the caller information only to at least one exclusive display for the driver so that only the driver is able to check the caller information.

2. The system of claim 1, wherein the notification unit for a driver outputs the caller information to at least one of a heads-up display, which is an exclusive display for the driver, and a digital cluster.

3. The system of claim 1, wherein the controller farther comprises an incognito mode setting unit configured to automatically set the incoming call-incognito mode when it is detected that a passenger is boarded.

4. The system of claim 1, wherein the notification unit for a driver is configured to output an incoming call tone along with the caller information and, only when the incoming call-incognito mode is not set, however, outputs the incoming call tone.

5. The system of claim 4, wherein, when the incoming call-incognito mode is set, the notification unit for a driver notifies the driver of an incoming call by activating a vibration motor provided in a driver's body contact area in place of outputting the incoming call tone.

6. The system of claim 1, wherein the controller further comprises a situation notification unit configured to transmit voice messages to a caller through the driver's phone for notifying the caller that a call is connected in a vehicle hands-free mode or that a passenger is on board, when a call channel is made between the driver's phone and the caller terminal according to a driver's acceptance command for a talk with respect to the incoming call.

7. The system of claim 6, wherein the controller further comprises a call processing unit configured not to output a caller's voice received from the driver's phone through the short-range wireless communication to a speaker during voice message guidance by the situation notification unit.

8. The system of claim 1, wherein the controller further comprises a call method setting unit configured to allow, according to a driver's button input pattern for call acceptance, a call to be accomplished through a microphone and speaker of the driver's phone by notifying vehicle hands-free deactivation to the driver's phone or the call to be accomplished through a microphone and speaker of the vehicle by notifying vehicle hands-free activation to the driver's phone and to allow switching to be accomplished between the hands-free activation and hands-free deactivation of the vehicle according to the driver's button input pattern in a state call acceptance is made.

9. A vehicle hands-free call connection method, wherein a vehicle hands-free incoming call notification method is performed by at least one process belonging to a vehicle hands-free incoming call notification system for supporting a hands-free function by being connected to a driver's phone and short-range wireless communication, the vehicle hands-free call connection method comprising:
receiving caller information through the short-range wireless communication from the driver's phone to which an incoming call is connected according to a call origination of a caller terminal; and
outputting received caller information to at least some displays among a plurality of vehicle displays and, when an incoming call-incognito mode is set, however, outputting the caller information only to at least one exclusive display for a driver.

10. The connection method of claim 9, wherein the outputting received caller information outputs the caller information to at least one of a heads-up display, which is an exclusive display for the driver, and a digital cluster.

11. The connection method of claim 9, further comprising:
automatically setting the incoming call-incognito mode when it is detected that a passenger is boarded.

12. The connection method of claim 9, wherein the outputting received caller information outputs an incoming call tone along with the caller information and, only when the incoming call-incognito mode is not set, however, outputs the incoming call tone.

13. The connection method of claim 9, wherein, when the caller information is received in a state in which the incoming call-incognito mode is set, the outputting received caller information outputs an incoming call tone along with caller information or notifies the driver of an incoming call by activating a vibration motor provided in a driver's body contact area.

14. The connection method of claim 9, further comprising:
transmitting voice messages to a caller through the driver's phone for notifying the caller that a call is connected in the vehicle hands-free mode or that a passenger is on board, when a call channel is made between the caller terminal and the driver's phone according to a driver's acceptance command for a talk with respect to the incoming call.

15. The connection method of claim 14, further comprising:
blocking a speaker output of a caller's voice received from the driver's phone through the short-range wireless communication during voice message guidance.
